(19) United States
(12) Patent Application Publication
(10) Pub. No.: US 2017/0040937 A1
(43) Pub. Date: Feb. 9, 2017

(54) ELECTRICAL ENERGY STORAGE MODULE FOR DEVICE FOR CONVERTING PHOTOVOLTAIC ENERGY INTO ELECTRICAL ENERGY

(71) Applicant: Olivier Panya KRUG, Carcassonne (FR)

(72) Inventor: Olivier Panya KRUG, Carcassonne (FR)

(21) Appl. No.: 15/304,515

(22) PCT Filed: Mar. 31, 2015
(86) PCT No.: PCT/EP2015/056963

§ 371 Date: Oct. 15, 2016

(30) Foreign Application Priority Data
Apr. 22, 2014 (FR) 1453587

(51) Int. Cl. H02S 40/32; H02J 3/38; H02S 40/42; H02S 50/00; H02S 40/38

(52) U.S. Cl. CPC H02S 40/32; H02S 50/00; H02S 40/38; H02S 40/42; H02J 3/383

(57) ABSTRACT

The invention relates to an electrical energy storage module (120) of a device (10) for converting photovoltaic energy into electrical energy, said electrical energy storage module (120) being characterised in that it is designed to be detachably mounted on said device (10).

### FIELD OF ART

The present invention relates to the field of renewable energy and concerns more particularly an electrical energy storage module and a device for converting photovoltaic energy into electrical energy comprising such a module.

The particular application of this invention is in the field of conversion of photovoltaic energy into electrical energy by a photovoltaic panel type device.

### STATE OF THE ART

The photovoltaic energy conversion devices are increasingly used today, especially because of the scarcity of non-renewable energies.

Photovoltaic energy is based on the photoelectric effect to create a continuous electrical current from electromagnetic radiation. This light source can be natural (sun) or artificial (a light bulb).

Photovoltaic energy is captured by photovoltaic cells, an electronic component that generates electricity when exposed to light. Several cells can be connected to form a photovoltaic panel and several panels can be connected to form a photovoltaic system, in a number that may vary from a few to several thousand.

The panel or photovoltaic system is usually directly connected to an electrical grid to provide said grid the electrical energy that the system produces. However, although, according to the Latin formula “sol omnibus lucet”, or the sun enlightens all, solar energy is only available during the day (or approximately 50% of the time on average over one year) or during certain months when we approach the poles, which can present a serious drawback for the continuous supply to electrical equipment connected to said grid.

To overcome this drawback, it is known to store the electrical energy produced by a photovoltaic panel or system in a temporary storage module. Energy can be stored directly as electrical energy or in another form.

In the latter case, it is, for example, known to store energy in the form of hydrogen, calories or a body of water brought back up in reservoirs when energy is available, and then used to generate electricity with “turbine action” when necessary. Such systems are large, complex and costly, which are significant drawbacks. In addition, it is necessary to convert the electrical energy produced by the photovoltaic panel or system into another form of energy, which can be time-consuming and cause a loss of electrical energy.

In the case of direct storage of electrical energy, it is known to use a system of one or more batteries in parallel for accumulating electrical energy. One solution, known from the patent application CN103280846 (A) “Flexible photovoltaic integrated power supply system” describes a device converting photovoltaic energy into photovoltaic panel type electrical energy connected to an electrical energy storage module.

Such a device, however, presents many disadvantages. First, it is necessary to provide a space for installing the storage module, which can be large, and connecting it to the solar panel with a cable, which may cause losses. In addition, the electrical energy storage module is only configured to work with a specific type and number of solar panels, which prevents its use with solar panels of different types. In addition, the task to increase the storage capacity in electrical energy is complex to implement with such a device, in particular when connecting a plurality of solar panels to each other and/or when it is necessary to increase their number. Furthermore, there are risks associated with the implementation of a bank comprising a plurality of powerful batteries: fragile and heavy elements, hazardous components (acid), very strong currents, short circuits, degassing, explosion hazards, need for protection and closed and ventilated premises. It is therefore necessary to have skills and a specific accreditation, for example according to EN standards 50272-1, 2, 3 and EN 1127-1, to implement and maintain this type of bank. Moreover, such a battery bank usually presents problems of imbalance between the batteries which make up the bank and it is then necessary to apply regularly equalization charges, a defective cell causing an overall malfunction of the battery bank. Another disadvantage is related to the concentration of a huge amount of energy in one place, which may cause, for example, a fire and therefore significant damage. Furthermore, such a battery bank does not allow optimizing the production of each solar panel to which it is connected because the set of solar panels appears as a single generator for the battery bank without distinguishing the panels that are effective from those that are not. Finally, such a battery bank requires the use of junction boxes to put the solar panels in series or in parallel, resulting in an additional cost and additional risk of malfunction.

The invention therefore aims to remedy these disadvantages by providing a storage module of electrical energy that is at once effective, simple, modular and adaptable to different types of devices for converting photovoltaic energy into electrical energy.

### SUMMARY

To this end, the invention firstly relates to an electrical energy storage module of a device for converting photovoltaic energy into electrical energy, said device comprising at least one photovoltaic panel, said electrical energy storage module being remarkable in that it is configured to be mounted removably on said photovoltaic panel.

Such electrical energy storage module can be easily mounted on a photovoltaic panel of a device for converting photovoltaic energy into electrical energy, making its replacement both fast and simple.

Advantageously, this storage module is light, its mass being preferably lower than 10 kg so as to make it easy to handle.

Preferably, this electrical energy storage module is configured to be integrated with a device for converting photovoltaic energy into electrical energy. Therefore, it is not necessary to provide a large space in the vicinity of the device. Such integration also allows avoiding the use of long cables synonyms of line losses.

Advantageously, the electrical energy storage module is configured to be mounted on the rear part of a device for converting photovoltaic energy into electrical energy.

Also advantageously, the electrical energy storage module comprises means for fastening it to a photovoltaic panel of a device for converting photovoltaic energy into electrical energy. Thus, for example, when the device comprises a photovoltaic panel comprising a frame, the fastening means may be arranged to mount the electrical energy storage module on said frame. Alternatively, when the device comprises a photovoltaic panel without frame, the fastening means may be arranged to mount the electrical energy storage module directly on the photovoltaic panel.

Preferably, the fastening means are fastening means by clamping, blocking or embedding, allowing particularly easy fastening of the module on the device, without skills or particular accreditation. For example, the fastening means may comprise one or more fastening blades or tabs. Such blades or tabs allow mounting the electrical energy storage module on different types of devices for converting photovoltaic energy to electrical energy.

Anti-theft means may further advantageously be provided to prevent the theft of the electrical energy storage module when mounted on a device for converting photovoltaic energy into electrical energy.

According to one aspect of the invention, the electrical energy storage module comprises means of adjustment allowing it to be fixed on photovoltaic panels of different dimensions, in particular on existing standard photovoltaic panel-type devices. Such means of adjustment may, for example, comprise one or more sliding parts.

According to another aspect of the invention, the electrical energy storage module is in the form of a substantially flat plate.

Preferably, the plate is of low thickness, for example less than 40 mm.

According to a feature of the invention, the electrical energy storage module comprises insulation means for protecting it from the high and low temperature of a device for converting photovoltaic energy into electrical energy on which it is mounted.

Preferably, the insulation means comprise an insulating strip, inexpensive and easy to mount on the storage module.

According to another characteristic of the invention, the electrical energy storage module comprises heat dissipating means in order to improve heat convection, particularly from a photovoltaic panel, and cooling said module.

According to one aspect of the invention, the electrical energy storage module comprises an inner face arranged to be disposed at the right rear side of a photovoltaic panel, and an outer face opposite said inner face.

Preferably, the insulating means are arranged at least on the inner face of the electrical energy storage module.

Also preferably, the heat dissipating means are arranged at least on the outer face of the electrical energy storage module in order to evacuate the heat to the outside of a device for converting photovoltaic energy into electrical energy on which the storage module is mounted.

Advantageously, the electrical energy storage module comprises first electrical connection means to a device for converting photovoltaic energy into electrical energy. Such first means allow avoiding the use of a junction box to put in series or in parallel several devices for converting photovoltaic energy into electrical energy, which significantly reduces the costs and risks of malfunction.

Preferably, these first connection means are in the form of one or more connectors, for example, the MC4 type known to those skilled in the art.

According to another characteristic according to the invention, the electrical energy storage module comprises second electrical connection means to at least another electrical energy storage module, preferably of the same type, in order to increase the storage capacity of electrical energy, in particular through a plurality of storage modules in parallel or in series. Increasing the storage capacity in electrical energy is thus easy to implement, especially when connecting several devices for converting photovoltaic energy into electrical energy between them and/or when increasing their number is desirable.

According to one aspect of the invention, the storage module comprises means of electrical protection against short-circuits such as, for example, a fuse or circuit breaker, in particular to avoid the use of external electrical protection means.

According to another aspect of the invention, the electrical energy storage module comprises at least one storage cell of electrical energy or one battery.

Preferably, the storage cell is a lithium battery that does not need specific skills accreditation. In addition, a lithium battery allows avoiding that a large amount of energy be concentrated in one place, thus significantly limiting the risks, which include fire.

Advantageously, the electrical energy storage module comprises a plurality of storage cells connected together, in parallel or in series, in particular to increase the storage capacity of the storage module and to spread over time the use of energy produced by the module.

Also preferably, the storage capacity of each storage lithium cell is between 30 and 150 Wh, these cells being combined to form a battery with an equivalent proportional capacity, for example from 300 to 1500 Wh for ten storage lithium cells.

Advantageously, the electrical energy storage module comprises ten LiFeP04 type storage cells (known to those skilled in the art) connected in series.

The invention also relates to a device for converting photovoltaic energy into electrical energy remarkable in that it comprises at least one electrical energy storage module as previously described.

The advantage of such a device is that it is not affected by the irregularity of photovoltaic production over time as it integrates its own electrical energy storage module.

In addition, when the device comprises a plurality of storage modules mounted in parallel and one of them is defective, the device continues to operate.

The device according to the invention can be connected to an electrical network or operate in isolation. The term “electrical network” means a network supplying electricity. The term “isolation” means that the device is not connected to an electrical network but is connected directly to a unit consuming electrical energy, such as, for example, an apartment building. Thus, if the electrical energy storage module is defective, the device remains operational, for example to supply electrical energy to an electrical network.

In addition, several devices according to the invention can be connected together easily and quickly in order to increase the capacity of energy production, making such a set modular and evolutionary. In this case, if one of the devices is defective, the others continue to produce, which optimizes the overall production of electricity.

Preferably, the device comprises at least one photovoltaic panel.

Preferably again, the photovoltaic panel comprises a plurality of photovoltaic cells configured to collect photovoltaic energy, for example solar energy, and a photovoltaic module configured to generate electrical energy from photovoltaic energy collected by the plurality of photovoltaic cells and to provide said electrical energy electrical to the electrical energy storage module and/or to an electrical network and/or to a unit consuming electrical energy.

Such a photovoltaic panel may comprise a frame, for example in aluminum, on which the electrical energy storage module is mounted.

When the electrical energy storage module is in the form of a plate, the thickness of the plate may advantageously be less than the thickness of the device. Thus, the module does not protrude from the photovoltaic panel, allowing the use of the majority of mounting systems and standard structures of existing devices.

Preferably, the electrical energy storage module has a nominal voltage close to the monitoring voltage of the maximum power point of the device in order to avoid the use of a monitoring unit of the maximum power point configured to continuously deliver maximum power to the electrical energy storage module. The monitoring voltage of the maximum power point, known to those skilled in the art, is generally between 25 and 35 Vdc, usually between 30 and 31 Vdc on average, for a solar panel-type device for converting photovoltaic energy into electrical energy.

Advantageously, the electrical energy storage module comprises ten LiFeP04 type storage cells connected in series for a nominal voltage of 32 Vdc, and the photovoltaic panel comprises sixty photovoltaic cells. The nominal voltage of the set formed by the ten storage cells is thus of the order of the nominal voltage of the set formed by the sixty photovoltaic cells.

According to a feature of the invention, the device comprises an internal inverter, connected to the electrical energy storage module, or is configured to be connected to an external inverter. An inverter is configured to convert the DC current from the storage unit or the solar module into alternating current useable to power loads. The internal inverter may be, for example, a micro-inverter and allow the injection of electrical current into an electrical network or a unit consuming current.

In a preferred aspect according to the invention, the storage module and/or the device comprises a management unit of the electrical energy storage module configured to protect it against significant shocks, short circuits, strong currents, surges and excessive temperature elevations and/or to manage the storage and destocking of electrical energy by the electrical energy storage module.

When the device comprises a plurality of electrical energy storage modules connected in parallel, the management unit of the electrical energy storage module may be configured to equalize them, for example during their period of inactivity. In addition, the malfunction of a storage module does not cause an overall malfunction of the whole set of storage modules, which represents a significant advantage.

According to a feature of the invention, the management unit comprises at least one indicator of the state of the electrical energy storage module, in particular its load, and means to quickly identify a malfunction. Such an indicator may be, for example, a light emitting diode (LED).

Advantageously, the management unit of the electrical energy storage module comprises a communication sub-unit configured especially to control the use of the electrical energy storage module, particularly in order to provide the electrical energy stored by the storage module to an electrical network, and/or to remotely check the state of the storage module.

Such communication sub-unit can be configured to communicate over a link that can be wired or wireless, for example by Power Line Carrier (PLC).

The invention also relates to a system comprising a device for converting photovoltaic energy into electrical energy, as previously described, and a terminal configured to communicate with the communication sub-unit of the electrical energy storage module management unit in order to control said management unit.

Preferably, the terminal comprises a screen for displaying the load state of the electrical energy storage module, including of each of its storage cells, and, if necessary, its voltage, its input current, its outgoing current and/or the commissioning or shutdown of said storage module.

Other features and advantages according to the invention will appear throughout the following description with reference to the annexed figures, shown as non-limiting examples in which identical references are given to similar objects.

### BRIEF DESCRIPTION OF THE DRAWINGS

FIG. 1 illustrates schematically an embodiment of a system according to the invention.

FIG. 2 is a rear view of an embodiment of a device for converting photovoltaic energy into electrical energy according to the invention.

FIG. 3a is a partially transparent view of the inner face of a first embodiment of a electrical energy storage module according to the invention.

FIG. 3b is a view of the outer face of a second embodiment of an electrical energy storage module according to the invention.

FIG. 4a is a partial sectional view of a first embodiment of a device according to the invention.

FIG. 4b is a partial sectional view of a second embodiment of a device according to the invention.

FIG. 5 illustrates a first implementation mode of the device according to the invention connected to an electrical network.

FIG. 6 illustrates a second implementation mode of the device according to the invention connected to an electrical network.

FIG. 7 illustrates a third implementation mode of the device according to the invention connected to an electrical network.

FIG. 8 illustrates a first implementation mode of the device according to the invention operating in isolated mode.

FIG. 9 illustrates a second implementation mode of the device according to the invention operating in isolated mode.

FIG. 10 illustrates a third implementation mode of the device according to the invention operating in isolated mode.

### DETAILED DESCRIPTION

I. System 1

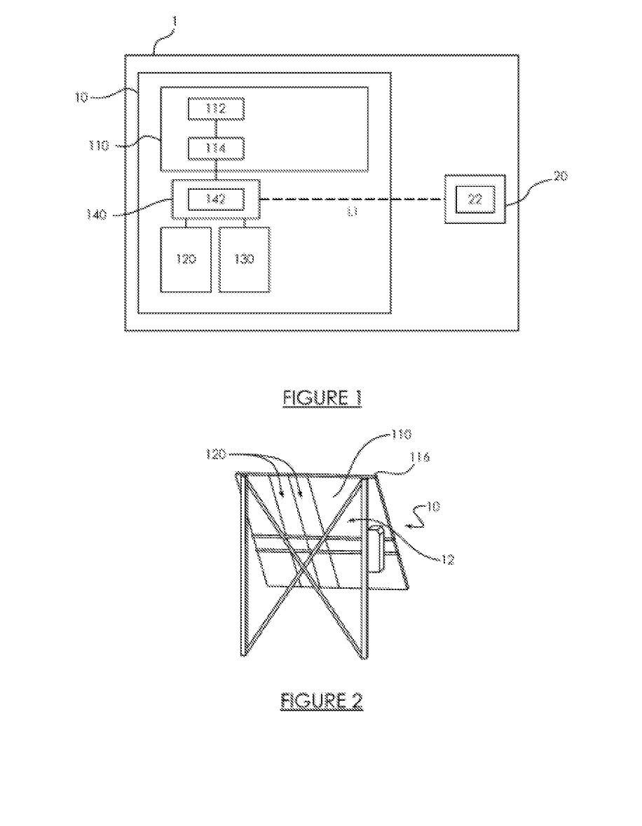

FIG. 1 illustrates schematically an embodiment of system 1 according to the invention. The system 1 comprises a device for converting photovoltaic energy into electrical energy 10 and a terminal 20.

A) Device 10

The device 10 according to the invention advantageously allows producing electrical energy from photovoltaic energy and storing it.

To this end, still in reference to FIG. 1, the device for converting photovoltaic energy into electrical energy 10 comprises a photovoltaic panel 110 and an electrical energy storage module 120.

The device according to the invention may be connected to an electrical network 30 (FIGS. 5 to 7) or operate in isolation by being connected directly to an electrical energy consuming unit 40, such as, for example, an apartment building (FIGS. 8 to 10).

The photovoltaic panel 110 comprises a plurality of photovoltaic cells 112 in the form of a substantially flat plate of low thickness, as known to those skilled in the art, and a photovoltaic module 114.

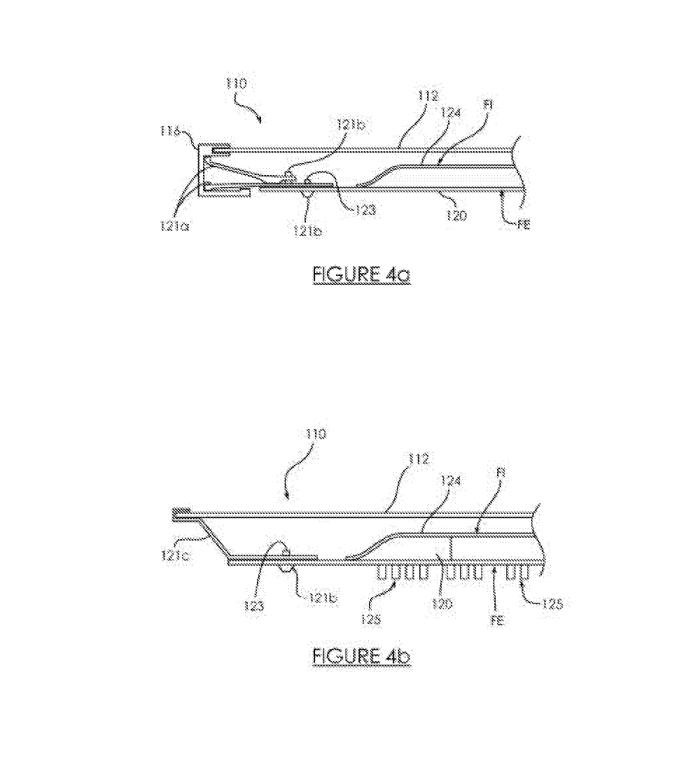

In an embodiment illustrated in FIG. 4a, the photovoltaic panel 110 further comprises a frame 116 placed around said plate, for example, made of aluminum, on which the electrical energy storage module 120 is mounted. Alternatively, as illustrated in FIG. 4b, the electrical energy storage module 120 may be mounted directly on the plate.

The plurality of photovoltaic cells 112 is configured to collect photovoltaic energy, for example solar energy, as known to those skilled in the art. A standard type solar panel may, for example, comprise sixty photovoltaic cells 112.

The photovoltaic module 114 is configured to generate electrical energy from photovoltaic energy collected by the plurality of photovoltaic cells 112 and to provide said electrical energy to the electrical energy storage module 120 and/or to the electrical network 30 and/or to an electrical energy consuming unit 40.

The device 10 further comprises an internal inverter 130 connected to the electrical energy storage module 120 and configured to convert the direct current stored in the storage module 120 into usable alternating current to power a variety of common electrical loads. Such internal inverter 130 may be a grid inverter in the electric network 30, for example a micro-inverter.

The device also comprises a management unit 140 of the electrical energy storage module 120 configured to protect it against significant shocks, short circuits, strong currents, surges and excessive temperature elevations and/or to manage the storage or destocking of electrical energy by the electrical energy storage module 120.

To this end, the management unit 140 is connected, on the one hand, to the photovoltaic module 114 and, on the other hand, to the electrical energy storage module 120 and to the internal inverter 130.

The management unit 140 may be mounted on the photovoltaic panel 110, for example, above or next to the electrical energy storage module 120.

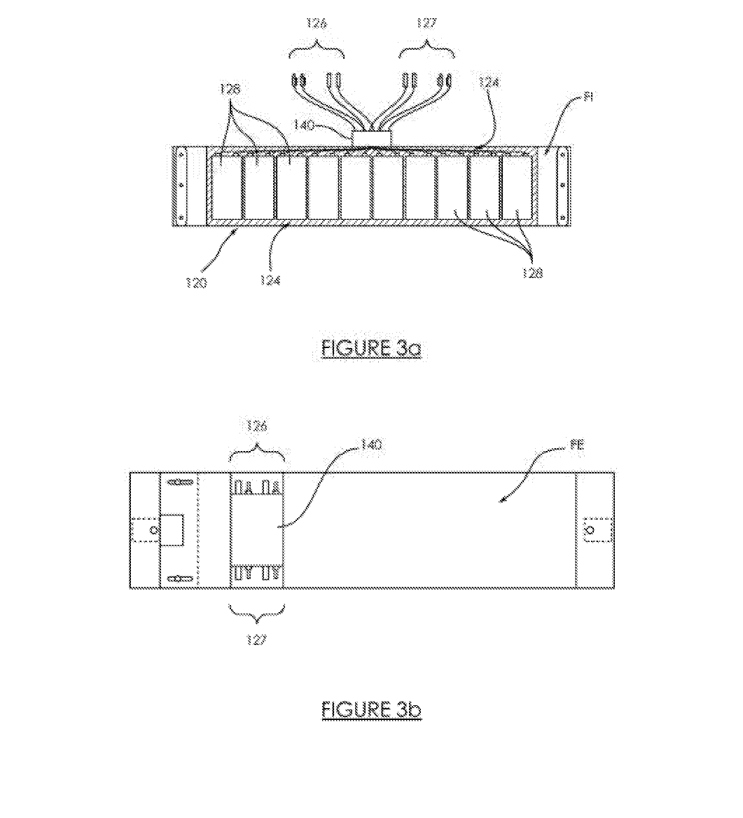

In this example, the management unit 140 is further configured to equalize the plurality of storage cells 128 (with reference to FIG. 3a) of the electrical energy storage module 120 by putting them in parallel during their period of inactivity.

The management unit 140 comprises at least one indicator of the load state of the electrical energy storage module 120 such as, for example, one or more Light Emitting Diodes (LEDs).

In the illustrated embodiment, the management unit 140 of the electrical energy storage module 120 comprises a communication sub-unit 142 configured to control the use of the electrical energy storage module 120, particularly so as to provide the electrical energy stored by the storage module 120 to an electrical network 30, and/or to remotely check the state of the storage module 120.

Such communication sub-unit 142 may be configured to communicate with a terminal 20 of a link L1 which can be wired or wireless, for example by Power Line Carrier (PLC).

B) Electrical energy storage module 120

The electrical energy storage module 120 is configured to be removably mounted on the device for converting photovoltaic energy into electrical energy 10.

In the two embodiments illustrated in FIGS. 3a to 4b, the electrical energy storage module 120 is in the form of a substantially flat plate of small thickness, for example inferior to 40 mm, and in particular lower than the thickness of the photovoltaic panel 110, thereby advantageously integrating the storage module 120 to the device for converting photovoltaic energy into electrical energy 10 without the storage module 120 protruding from the photovoltaic panel 110.

For example, the width of the storage module 120 may be between 100 and 500 mm and its length may be between 500 and 2000 mm.

As illustrated in FIGS. 4a and 4b, the electrical energy storage module 120 comprises an inner face FI arranged to be disposed in line with the rear side 12 of the photovoltaic panel 110, and an outer face FE opposite said inner face FI.

To this end, still in reference to FIGS. 4a and 4h, the electrical energy storage module 120 comprises means for fastening it to the photovoltaic panel 110.

In the example of FIG. 4a, the photovoltaic panel 110 comprises a frame 116 and the electrical energy storage module 120 is mounted on said frame 116 by means of blades or fastening tabs 121a and a system of screws and nuts 121b. Such fastening means especially allow mounting the electrical energy storage module 120 by embedding, by blocking or by clamping on different types of photovoltaic panels.

Such blades or fastening tabs 121a also allow attaching the electrical energy storage module 120 to the photovoltaic panel 110 without drilling in order to preserve the integrity of the aluminum frame 116. The parts in contact with the aluminum frame 116 may, for example, be either in aluminum or plastic to avoid any electrolytic torque.

In the example of FIG. 4b, the photovoltaic panel 110 does not comprise any frame. In this case, the securing means are in the form of one or more strips 121c fixed directly on the surface of the photovoltaic panel 110, for example by clamping.

The electrical energy storage module 120 further comprises means of adjustment, anti-theft means 123, insulation means 124, heat dissipation means 125 and first electrical connecting means 126 and second electrical connecting means 127.

Adjustment means may be provided to adjust the fastening of the electrical energy storage module 120 on devices 10 of different dimensions.

The adjustment means may, for example, be in the form of sliding parts (not represented) whose adjustment is achieved with the screws and nuts system 121b so as to adapt the length of the storage module 120 to the frame width 116 of the photovoltaic panel 110. The width may, for example, be adjustable over a length of 100 mm for a width of the photovoltaic module 110 comprised between 950 to 1,050 mm in order to accommodate a large number of photovoltaic modules of different types.

The adjustment of the length of the storage module 120 can also be achieved by using fastening means, for example, by adapting the length of the blades or tabs 121a or by using flexible blades or tabs 121a.

The anti-theft means 123 are, for example, in the form of self-breaking anti-theft screws or equipped with a tamper-proof head.

As shown in FIG. 3a, the insulation means 124 are configured to protect the electrical energy storage module 120 from high temperatures likely to be reached by the photovoltaic panel 110, particularly at its photovoltaic cells 112, for example above 40° C. as well as low temperature, such as below zero.

These insulation means 124 may advantageously be in the form of an insulating sheet having, for example, a white or reflective surface, mounted on the inner face FI of the storage module 120.

The heat dissipation means 125 are configured to improve heat convection, produced especially by the photovoltaic panel 110, and allow cooling the electrical energy storage module 120.

In this example, the dissipation means 125 are arranged on the outer face FE of the electrical energy storage module 120.

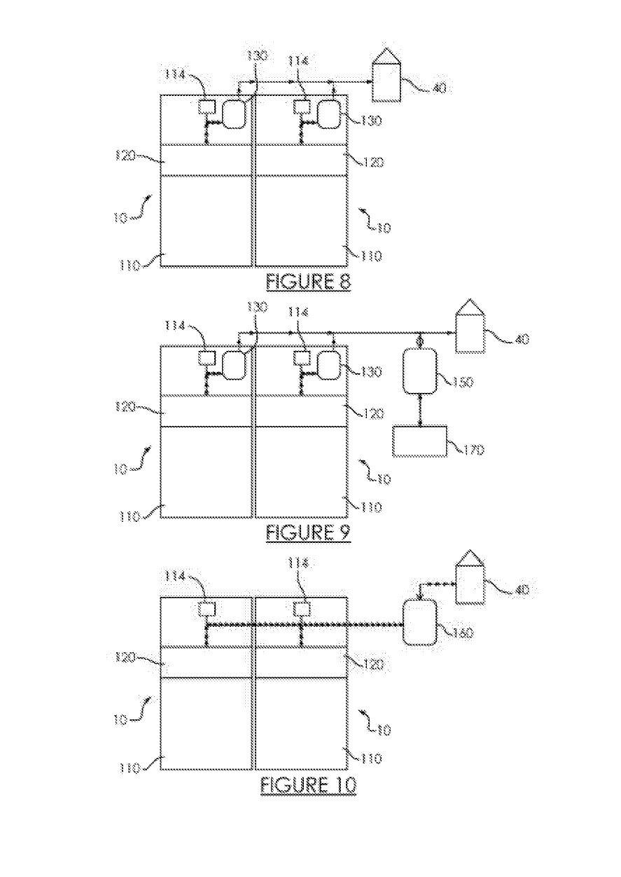

The first electrical connection means 126 are configured to electrically connect the electrical energy storage module 120, on the one hand, to the photovoltaic module 114 so as to store the electrical energy produced by the photovoltaic panel 110 and, on the other hand, to an internal inverter 130 or to an external inverter charger (reference FIG. 10) to provide it with the stored electrical energy. These first connection means 126 may be in the form of one or more connectors, for example, MC4 type known to those skilled in the art, as illustrated in the example of FIG. 3b, or power cables, as illustrated in the example of FIG. 3a.

The second electrical connection means 127 allow connecting the storage module 120 to at least another electrical energy storage module, preferably of the same type 120. In the example illustrated in FIG. 2, two electrical energy storage modules 120 are mounted in parallel on the rear face 12 of the photovoltaic panel 110 for converting photovoltaic energy into electrical energy in order to increase its electrical energy storage capacity.

These second connection means 127 can be in the form of one or more connectors, for example, MC4 type known to those skilled in the art, as illustrated in the example of FIG. 3b, electrical cables as illustrated in the example of FIG. 3a, or alternatively, for example, terminal blocks.

In order to store the energy produced by the photovoltaic panel 110, the storage module 120 comprises a plurality of electrical energy storage cells 128, lithium battery type, the storage capacity of each of its cells 128 being, for example, between 30 and 150 Wh. These storage cells 128 are interconnected in series in the storage module 120.

Advantageously, as partially shown transparently in FIG. 3a, the electrical energy storage module comprises ten “LiFeP04” type storage cells 128 connected in series for a nominal voltage of 32 Vdc in the storage module 120. The photovoltaic panel in this case may comprise, for example, sixty photovoltaic cells. The nominal voltage of the set formed by the ten storage cells 128 is thus of the order of the nominal voltage of the set formed by the sixty photovoltaic cells, thereby avoiding the use of a tracking unit of the maximum power point (known to those skilled in the art) configured to continuously deliver maximum power to the electric energy storage module.

A storage module 120 may, for example, have a capacity equivalent to a production day. A 250 Wc photovoltaic panel produces from 0 to 1750 Wh in one day depending on the amount of sunshine in the site. The LiFeP04 cells are 3.2 V nominal. Ten 3.2 V-30 Ah-storage cells 128 would thus produce 960 Wh nominal voltage of stored electrical energy.

Such electrical energy storage module 120 is light, e.g. less than 10 kg, to make it easy to handle.

The management unit 140 may be cast in resin to improve its temperature resistance, its shock resistance and prevent copying.

Finally, it can be envisaged to mount several electrical energy storage modules 120 in parallel in order to increase the total storage capacity of the device 10.

C) Terminal 20

The terminal 20 is configured to communicate with the communication sub-unit 142 of the management unit 140 of the device 10 in order to control said management unit 140. For example, the terminal 20 can be configured to control the load state of the electrical energy storage module 120, in particular each of its storage cells 128, its voltage, its input current, its outgoing current and/or the commissioning or shutdown of said storage module 120. To this end, the terminal 20 comprises in this example a screen 22 for displaying these parameters and controlling the management unit 140. It should be noted that any other control means of the management unit 140 may be used, e.g. buttons or control keys.

II. Implementation examples according to the invention

FIGS. 5-7 illustrate three modes of implementation of the device 10 according to the invention when it is connected to an electrical network 30.

In a first implementation mode, shown in FIG. 5, the internal inverter 130 injects electrical energy, produced by photovoltaic module 114 from the photovoltaic energy collected by the plurality of photovoltaic cells 112, directly into the electrical network 30.

In a second implementation mode, shown in FIG. 6, when the network cannot or should not accept the production, the photovoltaic module 114 provides the electrical energy produced to the storage module 120 which stores it in the storage cells 128. This can be used in particular to limit the maximum power injected on a low electrical network 30, to keep the surplus production in a subsistence installation, or even to adapt the production of the internal inverter 130 to local consumption.

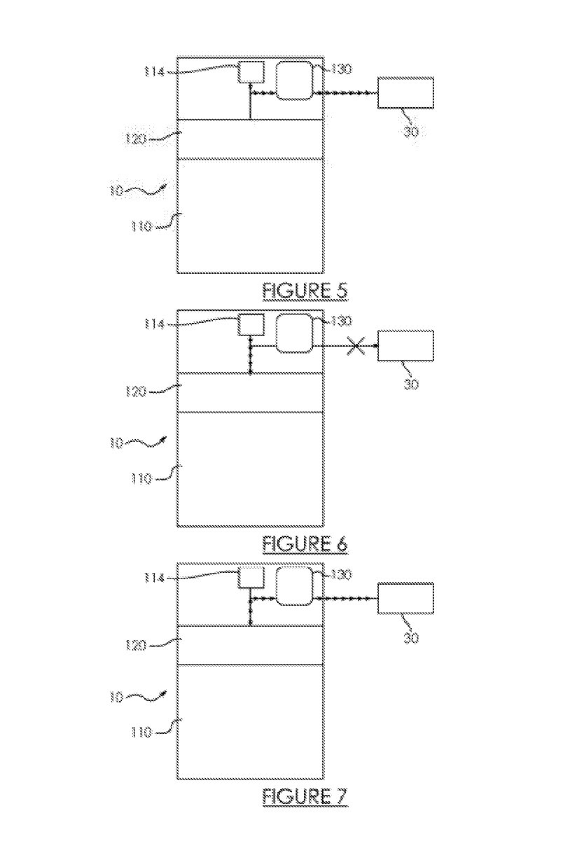

In a third implementation mode, shown in FIG. 7, the storage module 120 provides power to the internal inverter 130 which then injects electrical energy into the electrical network 30. This mode may be implemented when the photovoltaic module 114 does not produce any electricity, for example at night or during cloudy periods.

FIGS. 8-10 illustrate three implementation modes of the device 10 according to the invention operating in isolation, that is to say, when connected directly to an electrical energy consuming unit 40 such as, for example, an apartment building, a telecommunications relay, a lighting system or a factory. In these implementation modes, two conversion devices 10 are used for supplying electrical energy to the unit 40.

In a first implementation, shown in FIG. 8, each device 10 comprises a charger type internal inverter 130. These inverter chargers 130 operate in parallel in a configuration with one master and n slaves (here n=I) so that the master controls the one or more slaves, for example in frequency for monophasic synchronized operation or shifted to 120 for three-phase operation, to provide energy to the unit 40.

In a second implementation mode, shown in FIG. 9, each device 10 comprises an internal micro-inverter 130. An external inverter 150, for example a reversible inverter charger, allows frequency management and network operation with the internal micro-inverters 130 of the set formed by the devices 10 to provide energy to the unit 40. The external inverter 150 is further connected to a battery bank for storing part of the electrical energy supplied by the devices.

In a third implementation mode, shown in FIG. 10, the storage modules 120 of the devices 10 are connected in parallel with their respective second electrical connection means 127 and provide a voltage, for example between 20 and 36 Vdc, to an inverter charger or an external direct current converter 160 which in turn supplies the unit 40 and an external battery bank 170. It should be noted that, in the latter mode, the device 10 does not comprise an internal inverter 130.

During the implementation of the device 10 according to the invention, the terminal 20 may be used at any time to manage the one or more electrical energy storage module(s) 120, by communicating via the communication sub-unit 142 of the management unit 140 of the device 10. For example, the terminal 20 may be used to display the load state of the one or more electrical energy storage module(s) 120, in particular each of their storage cells 128, their voltage, their input current, their outgoing current and/or allow the commissioning or shutdown of said one or more storage module(s) 120.

The device according to the invention is advantageously not affected by the irregularity of photovoltaic production over time as it integrates electrical energy storage, and avoids the implementation difficulties of storage modes external to solar panels.

The supply of electricity can thus be easily managed, in particular by distributing it over the day, for example, by interrupting production of part of the internal inverters 130 at midday, then operating these internal inverters 130 at night.

In addition, several devices according to the invention can be connected together easily and quickly in order to increase the capacity of energy production, making such a set modular and evolutionary. In such case, if one of the devices is defective, the others continue producing.

If the device 10 does not comprise an internal inverter 130, the device 10 may be directly connected to an external inverter 160. In addition, maintenance and/or monitoring the device 10 may also advantageously be done remotely thanks to the terminal 20.

The electrical energy storage module 120 and the device 10 are thus both modular and evolutionary and it suffices to add one or more devices 10 to increase the capacity of the set. The electrical energy storage module 120 is also very easy to replace and can be replaced without accreditation or particular skills as part of the maintenance.

If the device 10 comprises several electrical energy storage modules 120 and one of them is defective, the others can continue to supply electricity. The installation and use of the electrical energy storage module 120 according to the invention are easy and do not require specific technical skills.

The electrical energy storage module 120 may also be mounted on most standard photovoltaic panels 110 without modification thereof. Finally, if the electrical energy storage module 120 fails, the photovoltaic panel 110 remains operational.

It should be noted, moreover, that the present invention is not limited to the examples described above and may be subject to numerous variants available to those skilled in the art.

In particular, the shapes of the photovoltaic panel 110 and the storage module 120, the number and type of storage cells 128, the nature of the fastening means, the adjustment means, the anti-theft means 123, the insulation means 124, the heat dissipation means 125, the first electrical connection means 126 and the second electrical connection means 127, as shown in the figures in order to illustrate an exemplary embodiment of the invention, cannot be interpreted as limiting.

1. An electrical energy storage module of a device for converting photovoltaic energy into electrical energy, said device comprising at least one photovoltaic panel, said electrical energy storage module being configured to be removably mounted on said photovoltaic panel.

2. The storage module according to claim 1, said storage module being configured to be integrated in a device for converting photovoltaic energy into electrical energy.

3. The storage module according to claim 1, said storage module being configured to be mounted on the rear part of a device for converting photovoltaic energy into electrical energy.

4. The storage module according to claim 1, said storage module comprising fastening means on a photovoltaic panel of a device for converting photovoltaic energy into electrical energy.

5. The storage module according to claim 4, wherein the fastening means are fastening means by clamping, by blocking or by embedding.

6. The storage module according to claim 1, said storage module comprising means of adjustment enabling it to be fastened on photovoltaic panels of different dimensions.

7. The storage module according to claim 1, said storage module being in the form of a substantially flat plate.

8. The storage module according to claim 1, said storage module comprising insulation means for protecting it from high and low temperatures of a device for converting photovoltaic energy into electrical energy on which it is mounted.

9. The storage module according to claim 1, said storage module comprising heat dissipating means.

10. The storage module according to claim 1, said storage module comprising a plurality of storage cells connected together, in parallel or in series.

11. A device for converting photovoltaic energy into electrical energy, said device comprising at least one electrical energy storage module according to claims 1.

12. The device according to claim 11, said device comprising an internal inverter connected to the electrical energy storage unit.

13. The device according to claims 11, said device comprising a monitoring unit of the electrical energy storage module configured to protect it against shocks, short circuits, strong currents, surges and temperature elevations and/or to manage the storage and destocking of electrical energy by the electrical energy storage module.

14. The device according to claim 13, wherein said monitoring unit comprises a communication sub-unit configured to control the use of the electrical energy storage module and/or to remotely check the state of the storage module.

15. A system comprising a device for converting photovoltaic energy into electrical energy according to claim 14 and a terminal configured to communicate with said communication sub-unit by Power Line Carriers for controlling the monitoring unit.
